(19) United States
(12) Patent Application Publication
(10) Pub. No.: US 2019/0102890 A1
(43) Pub. Date: Apr. 4, 2019

(54) METHOD AND SYSTEM FOR TRACKING OBJECT

(71) Applicant: Acer Incorporated, New Taipei City (TW)

(72) Inventor: Chueh-Pin Ko, New Taipei City (TW)

(73) Assignee: Acer Incorporated, New Taipei City (TW)

(21) Appl. No.: 15/849,639

(22) Filed: Dec. 20, 2017

(30) Foreign Application Priority Data
Oct. 3, 2017 (TW) 106134271

(51) Int. Cl. G06T 7/246; G02B 27/01

(52) U.S. Cl. CPC G06T 7/248; G02B 27/0172; G06T 2207/10016; G06T 2207/10152; G02B 2027/014; G06T 2207/30244; G02B 2027/0138

(57) ABSTRACT

An object-tracking method and system are provided. A light beam is emitted by a light emitter of each of a plurality of assembly pads. A plurality of images toward the assembly pads are continuously captured by an image pickup apparatus, wherein each image includes a plurality of light regions formed by the light beams. A first image and a second image are analyzed to calculate a change of movement of the light regions, wherein the first image and the second image are two adjacent images. Thereafter, a motion state of the image pickup apparatus is determined based on the change of movement.

### CROSS-REFERENCE TO RELATED APPLICATION

This application claims the priority benefit of Taiwan application serial no. 106134271, filed on Oct. 3, 2017. The entirety of the above-mentioned patent application is hereby incorporated by reference herein and made a part of this specification.

### BACKGROUND OF THE INVENTION

### 1. Field of the Invention

The invention relates to an object-tracking method and an object-tracking system, and particularly relates to an object-tracking method and an object-tracking system incorporating light emitting assembling pads.

### 2. Description of Related Art

Through the development of science and technology, virtual reality (VR), augmented reality (AR), and mixed reality (MR) technologies become more and more matured. Also, the public has become more and more familiar with the notions of AR, VR, and MR. Thus, the user's demand to input in physical and virtual spaces is continuously on the increase. As a consequence, more and more corresponding input apparatuses such as helmets, sticks, and the like are now available, and the spatial positioning technique for immersive experience becomes particularly important.

The VR techniques nowadays define a user movement with a physical frame or a virtual optical frame. Thus, where the user is located is limited. For example, the space may be coded with laser to keep track of objects to be detected such as a helmet, a stick, or the like. Alternatively, a quick response (QR) code may be scanned and identified to gain access to information and present virtual information in a physical space. Thus, how to offer an interactive technique that is simple and generally applicable across various locations becomes an issue to work on.

### SUMMARY OF THE INVENTION

The invention provides an object-tracking method and an object-tracking system, where a light emitting assembly pad is incorporated for spatial positioning. Hence, object tracking is able to be implemented in various locations.

An object-tracking method according to an embodiment of the invention includes steps as follows. A light beam is emitted by a light emitter of each of a plurality of assembly pads, wherein the assembly pads form a light emitting region. A plurality of images toward the assembly pads in the light emitting region are continuously captured by an image pickup apparatus, wherein each of the images includes a plurality of light regions formed by the light beams. A first image and a second image are analyzed to calculate a change of movement of the light regions, wherein the first image and the second image are adjacent images in the images. Then, a motion state of the image pickup apparatus is determined based on the change of movement.

According to an embodiment of the invention, analyzing the first image and the second image to compute the change of movement of the light regions includes: locking a designated light region in each of the first image and the second image; and calculating a direction of movement and an amount of movement on a horizontal plane based on a coordinate position of the designated light region in the first image and a coordinate position of the designated light region in the second image.

According to an embodiment of the invention, analyzing the first image and the second image to compute the change of movement of the light regions includes: locking an imaging position in each of the first image and the second image; and recording a first light region of the imaging position in the first image; recording a second light region of the imaging position in the second image; obtaining a direction of movement on a horizontal plane based on a positional relation between the first light region and the second light region; and obtaining an amount of movement on the horizontal plane based on the number of light regions included between the first light region and the second light region.

According to an embodiment of the invention, analyzing the first image and the second image to compute the change of movement of the light regions includes: locking a designated light region in each of the first image and the second image; recording a first interval when the same interval is kept between the designated light region and the light regions adjacent to the designated light region in the first image; recording a second interval when the same interval is kept between the designated light region and the light regions adjacent to the designated light region in the second image; obtaining a direction of movement and an amount of movement on a vertical axis based on a change between the first interval and the second interval under a circumstance that the first interval differs from the second interval.

According to an embodiment of the invention, the change of movement is determined to be a horizontal movement under a circumstance that the first interval is equal to the second interval.

According to an embodiment of the invention, analyzing the first image and the second image to compute the change of movement of the light regions includes: determining whether there is any change between slopes of lines formed by the light regions on an exterior side in the first image and the second image. In addition, determining the motion state of the image pickup apparatus based on the change of movement includes calculating a rotation angle of the image pickup apparatus based on the change between the slopes.

According to an embodiment of the invention, the object-tracking method further includes: obtaining an identity code of each of the assembly pads; driving the assembly pads to sequentially emit light beams; obtaining a physical space location where each of the assembly pads is arranged based on a light signal and a captured image that are received; and matching the identity code and the corresponding physical space location to obtain a correspondence map.

According to an embodiment of the invention, the object-tracking method further includes: capturing a correction image toward the assembly pads in the light emitting region by the image pickup apparatus and displaying the correction image on a screen; displaying an ideal light region above the correction image on the screen; and performing a correction process in the ideal light region and the light regions in the correction image.

According to an embodiment of the invention, each of the assembly pads is provided with a male/female mechanical connector on an edge, and each of the assembly pads is assembled through the male/female mechanical connector.

According to an embodiment of the invention, the image pickup apparatus is mounted on an object, and the object is one of a helmet, a stick, a remote controller, a glove, a shoe cover, and clothes.

According to an embodiment, each of the assembly pads further includes a force sensor.

An object-tracking system according to an embodiment of the invention includes a plurality of assembly pads and an image pickup apparatus. The assembly pads are assembled to form a light emitting region, and each of the assembly pads includes a light emitter configured to emit a light beam. The image pickup apparatus includes an image capturer and an image analyzer. The image capturer continuously captures a plurality of images toward the assembly pads in the light emitting region. Each of the images includes a plurality of light regions formed by the light beams. The image analyzer is coupled to the image capturer and receives the images, and analyzes the images. In addition, the image capturer analyzes a first image and a second image to calculate a change of movement of the light regions. The first image and the second image are adjacent images in the images. In addition, the image analyzer determines a motion state of the image pickup apparatus based on the change of movement.

Based on the above, the light emitting assembly pads are incorporated in the embodiments of the invention. A range of activity is defined by using the assembly pads, so as to track a specific object in the range of activity. Hence, the number of the assembly pads may be increased or decreased based on the needs, making the use of the assembly pads more flexible and expandable without being limited by the location. The assembly pads are not only easy to assemble, but are also easy to remove.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an object-tracking system according to an embodiment of the invention.

FIG. 2 is a block diagram illustrating an object-tracking system according to an embodiment of the invention.

FIG. 3 is a flowchart illustrating an object-tracking method according to an embodiment of the invention.

FIG. 4 is a schematic view illustrating triangulation according to an embodiment of the invention.

FIG. 5 is a schematic view of presentation of light regions of images in a horizontal movement according to an embodiment of the invention.

FIG. 6 is a schematic view of presentation of light regions of images in a vertical movement according to an embodiment of the invention.

FIG. 7 is a schematic view of presentation of light regions of images in a rotation according to an embodiment of the invention.

FIGS. 8A and 8B are schematic views illustrating correction frames according to an embodiment of the invention.

FIG. 9 is a block diagram illustrating an object-tracking system according to another embodiment of the invention.

FIGS. 10A to 10C are schematic views illustrating configurations of an assembly pad according to an embodiment of the invention.

FIGS. 11A to 11C are schematic views illustrating configurations of an assembly pad according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It is to be understood that both the foregoing and other detailed descriptions, features, and advantages are intended to be described more comprehensively by providing embodiments accompanied with figures hereinafter. In the following embodiments, wordings used to indicate directions, such as “up,” “down,” “front,” “back,” “left,” and “right”, merely refer to directions in the accompanying drawings. Therefore, the directional wording is used to illustrate rather than limit the invention. In addition, in the following embodiments, like or similar components are referred to with like or similar reference symbols.

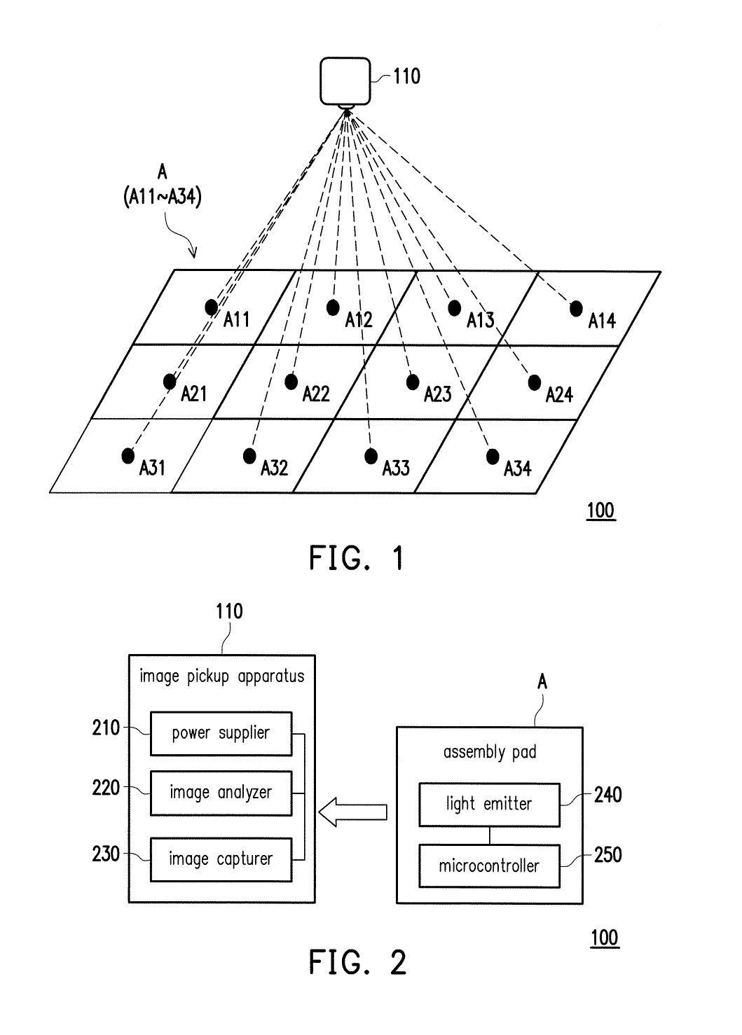

FIG. 1 is a schematic view illustrating an object-tracking system according to an embodiment of the invention. FIG. 2 is a block diagram illustrating an object-tracking system according to an embodiment of the invention. Referring to FIGS. 1 and 2, an object-tracking system 100 includes an image pickup apparatus 110 and assembly pads A11 to A14, A21 to A24, and A31 to A34 (generally referred to as assembly pads A in the following). The embodiment is described herein as including 4×3 assembly pads, for example. However, the embodiments of the invention are not limited thereto.

In addition, each of the assembly pads A includes a light emitter 240 and a microcontroller 250. The microcontroller 250 is coupled to the light emitter 240. The light emitter 240 is controlled through the microcontroller 250 to emit a light beam at a specific frequency, such as an infrared light beam. A wavelength of the infrared light beam may be designed to be 850 nm or 940 nm. The light emitter 240 may be an infrared light emitter to emit infrared light. The microcontroller 250 is an integrated circuit chip, and may be considered as a microcomputer. In the embodiment, each of the assembly pads A is in a square shape, and the light emitter 240 is disposed at a central position of each of the assembly pads A. In addition, the respective assembly pads A are in the same size. A light emitting region is formed by assembling the assembly pads A, and the image pickup apparatus 110 is adopted as a positioning apparatus and configured for spatial positioning. However, in other embodiments, the assembly pad may also be in a triangular, rectangular, hexagonal, or other polygonal shapes. The invention does not intend to impose a limitation on this regard.

The image pickup apparatus 110 may be installed on various objects, such as a helmet, a stick, a remote controller, a glove, a shoe cover, clothes, or the like. The image pickup apparatus 110 includes a power supplier 210, an image analyzer 220, and an image capturer 230. The power supplier 210 is coupled to the image analyzer 220 and the image capturer 230 to supply power. The image analyzer 220 is coupled to the image capturer 230.

Here, the power supplier 210 is a battery, for example. The image capturer 230 is a video capturer, a photo capturer, or other suitable devices including a charge coupled device (CCD) lens or a complementary metal oxide semiconductor transistor (CMOS) lens and is configured to capture an image. In addition, the image capturer 230 may also be a three-dimensional image capturing lens for three-dimensional detection, such as dual camera lenses, a structured light (light coding) lens, a lens with time-of-flight (TOF) technology, or a high-speed camera lens (>60 Hz, such as 120 Hz, 240 Hz, or 960 Hz). The image analyzer 220 is a central processing unit (CPU), a graphic processing unit (GPU), a physics processing unit (PPU), a programmable microprocessor, an embedded control chip, a digital signal processor (DSP), an application specific integrated circuit (ASIC), or other similar devices, for example.

The image pickup apparatus 110 may continuously capture a plurality of images toward the assembly pads A in the light emitting region. In other words, when the image pickup apparatus 110 moves along and rotate about the three coordinate axes in a coordinate system of a three-dimensional space (e.g., movements in six degrees of freedom, such as up-and-down movement, horizontal movement, vertical movement, and rotation corresponding to the three axes), the image pickup apparatus 110 may receive images having different light regions. Then, the image analyzer 220 may analyze the images to keep track of a motion state of the image pickup apparatus 110.

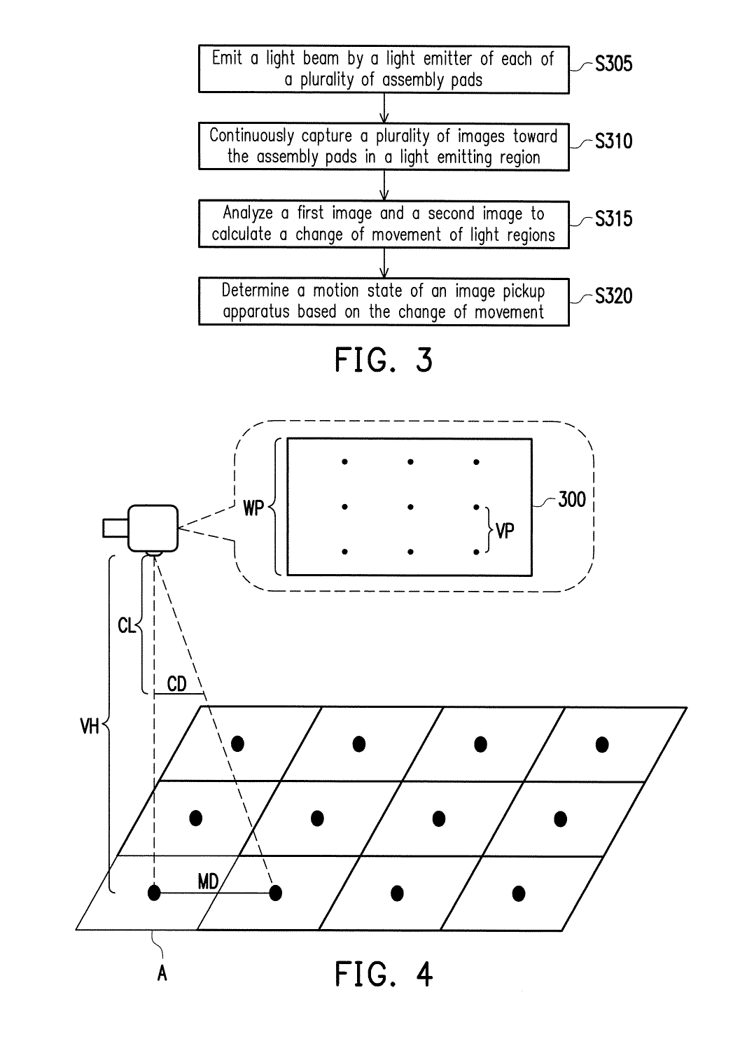

FIG. 3 is a flowchart illustrating an object-tracking method according to an embodiment of the invention. Referring to FIG. 3, at Step S305, a light beam is emitted by the light emitter 240 of each of the assembly pads A. For example, the image pickup apparatus 110 may transmit a control signal to the assembly pad A, so that the microcontroller 250 may drive the light emitter 240 to emit the light beam. Alternatively, the assembly pad A may be connected to an external electronic apparatus (an apparatus having a computing capability) in a wired or wireless manner, and the electronic apparatus may transmit a control signal to the assembly pad A. Accordingly, the microcontroller 250 may drive the light emitter 240 to emit the light beam.

Then, at Step S310, a plurality of images toward the assembly pads A in the light emitting region may be continuously captured by the image pickup apparatus 110. In addition, each of the images includes a plurality of light regions formed through the light beam. The image pickup apparatus 110 may receive the respective light beams emitted by the light emitters 240 of the respective assembly pads A, thereby forming the light regions in the formed images. Here, the light region may be forming by one or a plurality of light spots. The light spots may be considered as a set of light spots and the light spots are adjacent light spots.

Then, at Step S315, a first image and a second image are analyzed by using the image analyzer 220, so as to calculate a change of movement of the light regions. Here, for the ease of descriptions, two adjacent images are referred to as the first image and the second image. Then, at Step S320, a motion state of the image pickup apparatus 110 is determined based on the change of movement. The images received by the image pickup apparatus 110 may have different presentations of light regions. By analyzing the first image and the second image having different light regions, the motion state of the image pickup apparatus 110 in the six degrees of freedom is determined.

By mounting the image pickup apparatus 110 to different objects, the motion status of the image pickup apparatus 110 may represent a motion status of the objects by carrying out Steps S305 to S320.

In the following, an example is provided to describe the change of movement of the light regions.

FIG. 4 is a schematic view illustrating triangulation according to an embodiment of the invention. Referring to FIG. 4, VH represents an actual height between the image pickup apparatus 110 and the assembly pad A, CL represents a capturing focal length of the image pickup apparatus 110, MD represents an actual distance between central points of two adjacent assembly pads A in a preset direction, and CD represents an internal capture distance of the image capturer 230.

An image 300 is an image received by the image pickup apparatus 110. Here, the image 300 includes 9 light regions. WP is defined as a total number of pixels of the image 300 on the vertical axis, and VP is defined as a pixel interval between central points of two adjacent light regions on the vertical axis.

A formula for calculation is as follows:

$$VH = CL \times \frac{MD}{CD} ,$$

wherein

$$CD = CC \times \frac{VP}{WP} ,$$

and CC represents a frame conversion constant.

Hence,

$$VH = CL \times MD \times \frac{1}{CD} = CL \times MD \times \frac{WP}{VP \times CC} . \qquad ( Formula ( 1 ) )$$

Based on Formula (1), the image analyzer 220 may obtain an amount of movement on the vertical axis. Meanwhile, the image analyzer 220 may also obtain an amount of movement on the horizontal axis based on Formula (1). In other words, WP is defined to be a total number of pixels of the image 300 on the horizontal axis, and VP is defined as a pixel interval between the central points of two adjacent light regions on the horizontal axis.

Here, the user may input his/her height to set an actual height VH. For example, when the user inputs his/her height as 160 cm, the image analyzer 220 is able to set the actual height VH based on a general distance between eyes and the top of the head. Besides, the capturing focal length CL, the total number of pixels WP, and the frame conversion constant CC are known fixed values. Accordingly, by analyzing an amount of movement (number of pixels) between the first image and the second image, the pixel interval VP is obtained. Then, the actual distance MD may be obtained based on Formula (1) and serve to represent a distance of movement of the image pickup apparatus 110 in the physical space.

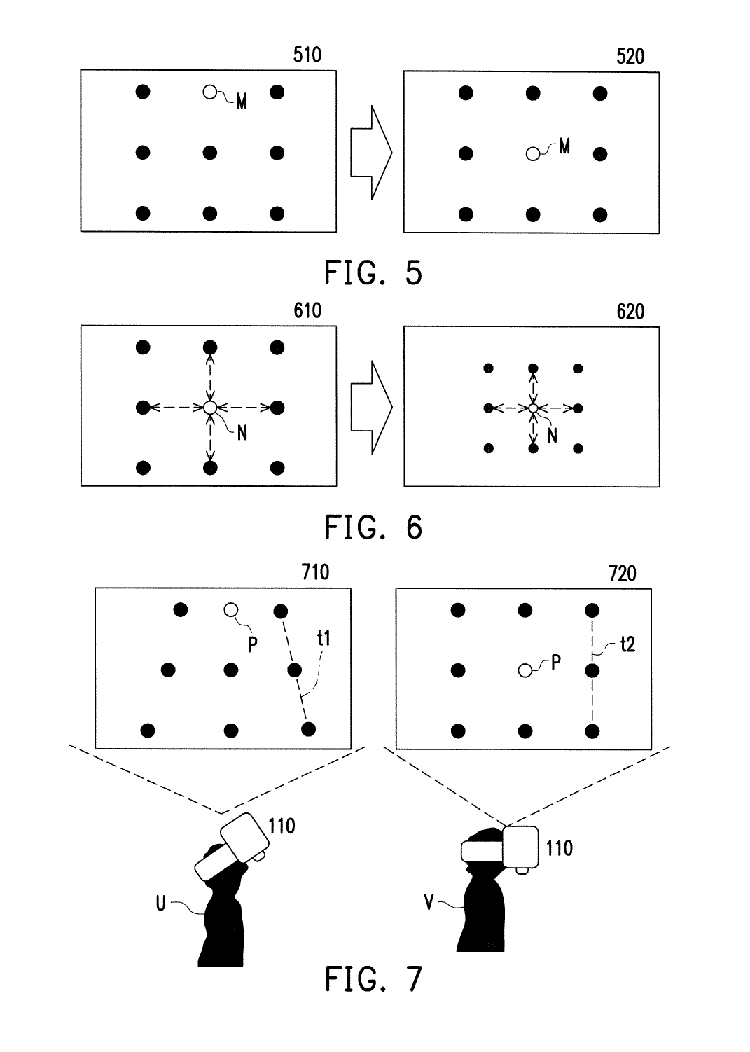

FIG. 5 is a schematic view of presentation of light regions of images in a horizontal movement according to an embodiment of the invention. In the embodiment, pixels are calculated by locking the light regions. Specifically, a designated light region is locked through image detection, and the number of pixels that the designated light region moves is substituted into Formula (1) to obtain the distance of movement.

Referring to FIG. 5, a designated light region M is locked in the first image 510 and the second image 520, respectively. Then, based on a coordinate position of the designated light region M of the first image 510 and a coordinate position of the designated light region M of the second image 520, a direction of movement and an amount of movement on a horizontal plane are calculated. Taking FIG. 5 as an example, the movement is in a forward direction, and the amount of movement is 1024 pixels, for example.

In an example with 16 million (5312×2988) pixels, the total number of pixels WP on the vertical axis is a fixed value of 2988. In addition, it is assumed that the frame conversion constant CC is a fixed value of 7 cm, the capturing focal distance CL is a fixed value of 12 cm, and the actual height VH is a fixed value of 150 cm.

By substituting the number of pixels that designated light region moves, such as 1024 pixels, into Formula (1), the corresponding actual distance MD is 30 cm. Based on the same principle, if the designated light region moves 2048 pixels, the corresponding actual distance is 60 cm. In other embodiments, the same principle still applies in detection of a left-and-right movement.

Alternatively, the amount of movement may be obtained by point-recording. Specifically, the process includes the following: locking an imaging position in each of the first image 510 and the second image 520; recording a first light region of the imaging position in the first image 510; recording a second light region of the imaging position in the second image 520; obtaining the direction of movement on a horizontal plane based on a positional relation between the first light region and the second light region; and obtaining the amount of movement on the horizontal plane based on the number of light regions included between the first light region and the second light region.

For example, assuming that the position of the designated light region M in the first image 510 is designated to be a locked imaging position, and another light region adjacent to the designated light region M is moved to the locked imaging position in the second image 520 after a front-back movement, based on Formula (1) (also assuming that the pixel interval VP between the two regions is 1024 pixels), it is learned that the movement is a forward 30-cm movement. In addition, if a movement crosses two light regions and ends at the third light region, it is indicated that the amount of movement is 90 cm. If the movement ends between light regions, the amount of the movement may still be calculated based on the proportion. Based on the same principle, the left-and-right movement may also be determined. The details of locking and recording light regions are not limited to the above.

FIG. 6 is a schematic view of presentation of light regions of images in a vertical movement according to an embodiment of the invention. In the embodiment, a vertical movement is detected when an interval between light regions is fixed. A designated light region N is locked in a first image 610 and a second image 620, respectively. In the first image 610, a first interval is recorded when the same interval is kept between the designated light region N and the four light regions adjacent to the designated light region N. In the second image 620, a second interval is recorded when the same interval is kept between the designated light region N and the four light regions adjacent to the designated light region N. Under the circumstance that the first interval differs from the second interval, a direction of movement and an amount of movement on the vertical axis are obtained based on a change between the first interval and the second interval.

Under the circumstance that the first interval is equal to the second interval, it is determined that the change of movement is a horizontal movement. In other words, whether the same interval is kept between the designated light region N and the four adjacent light regions is detected by detecting the designated light region N and the four adjacent light regions. The same interval indicates that a leveled state. When the image pickup apparatus 110 moves up and down, such as a case when the user wears a helmet with the image pickup apparatus 110 while squatting and standing, even though the intervals between the light regions in each of two adjacent images are the same, the sizes of the intervals may differ.

As shown in FIG. 6, assuming that the first interval in the first image 610 is 1024 pixels, and the second interval in the second image 620 is 615 pixels, it is learned based on Formula (1) that the image pickup apparatus 110 is vertically moved from 150 cm in height to 90 cm.

FIG. 7 is a schematic view of presentation of light regions of images in a rotation according to an embodiment of the invention. In the embodiment, rotation is detected when an interval between light regions are fixed. Here, the user wears a helmet with the image pickup apparatus 110. In a head-rising state U, the image pickup apparatus 110 obtains a first image 710, and in a state V when the user looks at eye level, the image pickup apparatus 110 obtains a second image 720. The image analyzer 220 determines whether there is any change between slopes of lines t1 and t2 formed by the light regions on an exterior side in the first image 710 and the second image 720, and a rotation angle of the image pickup apparatus 110 is calculated based on the change between slopes. For example, a tangent function may be adopted to calculate a head-rising angle, i.e., the rotation angle of the image pickup apparatus 110.

Besides, a designated light region P may be locked in the first image 710 and the second image 720 to detect intervals between the designated light region P and the adjacent light regions. The change of the rotation angle of the image pickup apparatus 110 may also be obtained based on a change of intervals between the designated light region P and the adjacent light regions between the first image 710 and the second image 720. Here, the intervals between the designated light region P and the adjacent light regions on the horizontal axis in the first image are smaller than the intervals between the designated light region P and the adjacent light regions on the horizontal axis in the second image 720. Accordingly, there is a rotation change of the image pickup apparatus 110 in the vertical direction.

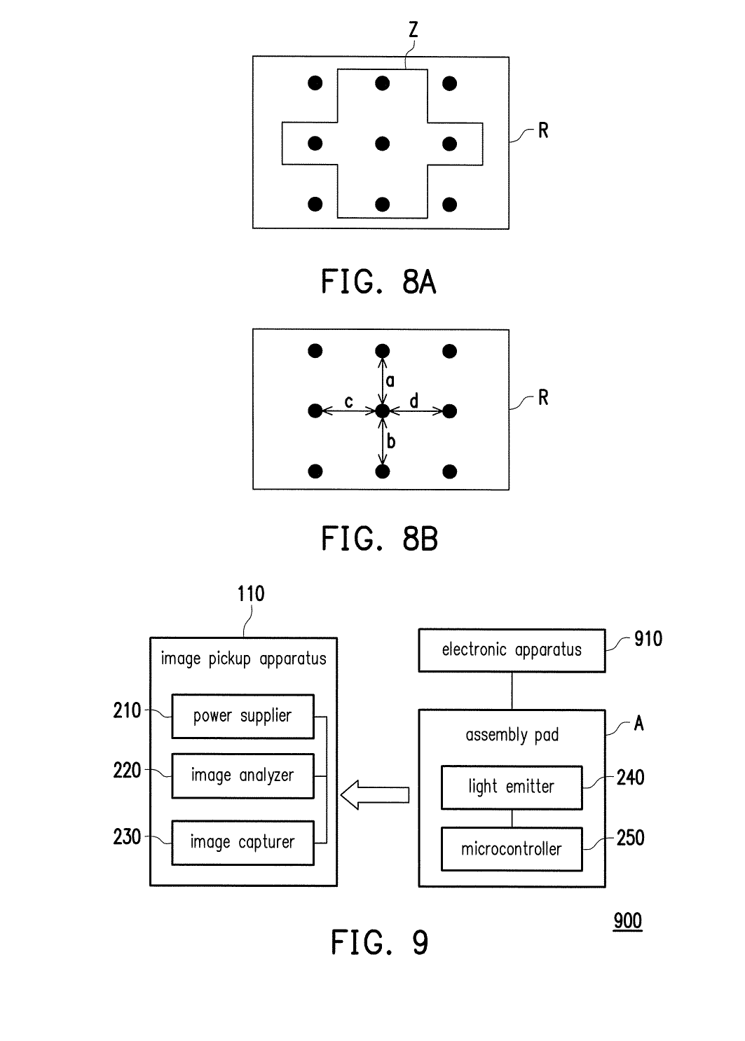

FIGS. 8A and 8B are schematic views illustrating correction frames according to an embodiment of the invention. Before actual use, a correction process may be carried out. Specifically, the light emitting region is obtained by assembling the assembly pads 120. Then, the image pickup apparatus 110 is turned on. Afterwards, the image pickup apparatus 110 is moved to the light emitting region. Here, the user may wear the helmet with the image pickup apparatus 110 and enter the light emitting region or hold the stick with the image pickup apparatus 110 and enter the light emitting region. Then, an ideal light region Z, as shown in FIG. 8A, is shown on a screen R of the image pickup apparatus 110. When the image pickup apparatus 110 enters the light emitting region and the deviation of images at a fixed position is very limited, it may be determined that the apparatus is positioned and remains still.

Then, lengths a and b between a central light region and adjacent light regions in a longitudinal direction and lengths c and d between the central light region and adjacent light regions in a lateral direction are detected. In addition, whether a ratio a/b between longitudinal lengths and a ratio c/d between lateral lengths are smaller than a preset value is determined. For example, a ratio between the length a and the length b should be less than 5%, and a ratio between the length c and the length d should be less than 5%.

FIG. 9 is a block diagram illustrating an object-tracking system according to another embodiment of the invention. In the embodiment, an object-tracking system 900 further includes an electronic apparatus 910. The electronic apparatus 910 may be connected to the assembly pads A in a wired or wireless manner. For example, the electronic apparatus 910 may be connected to the assembly pads A via a universal serial bus (USB) connection, a Bluetooth connection, a WiFi connection, or the like. The electronic apparatus 910 may be a desktop computer, a notebook computer, a tablet computer, a smartphone, or other electronic apparatuses having a computing capability.

Before starting object tracking, a correspondence map between a virtual space and a physical space may be built by using the electronic apparatus 910. The electronic apparatus 910 may detect the light beams of all of the assembly pads A in a wired or wireless manner and obtain identity codes of the light emitters 240 of all of the assembly pads A. Besides, the electronic apparatus 910 may request the respective assembly pads A to emit the light beams based on a specific timing, in a specific intensity, or in a specific flashing manner. After the image capturer 230 of the image pickup apparatus 110 receives light signals and captured images, a physical space location where each of the assembly pads is arranged is obtained, and the identity codes may be matched with the corresponding physical space locations to generate the correspondence map. Besides, in other embodiments, the correspondence map may be built in the image pickup apparatus 110. The invention does not intend to impose a limitation on this regard.

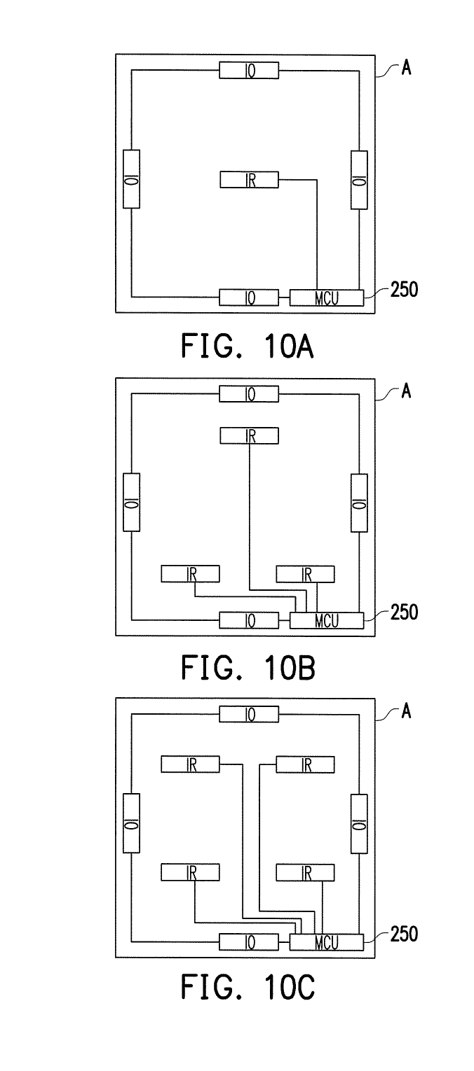

FIGS. 10A to 10C are schematic views illustrating configurations of an assembly pad according to an embodiment of the invention. Here, an infrared light source IR serves as the light emitter. The infrared light source IR may be formed in a single region or multiple regions on a single assembly pad, and each region includes at least one infrared light emitting diode (IRLED). The assembly pad A shown in FIG. 10A includes one infrared light source IR, the assembly pad A shown in FIG. 10B includes three infrared light sources IR, and the assembly pad A shown in FIG. 10C includes four infrared light sources IR. Each assembly pad A is in a square shape and is provided with a male/female mechanical connector on an edge. The assembly pads A may be arranged individually or as a pair, and positions of the male and female connectors may be adjacent or opposite to each other. An electrical connector IO is provided on the mechanical connector. In addition, the mechanical connectors may be completely male, completely female, or mixed on a side and used with the electrical connectors IO for matching in electrical properties.

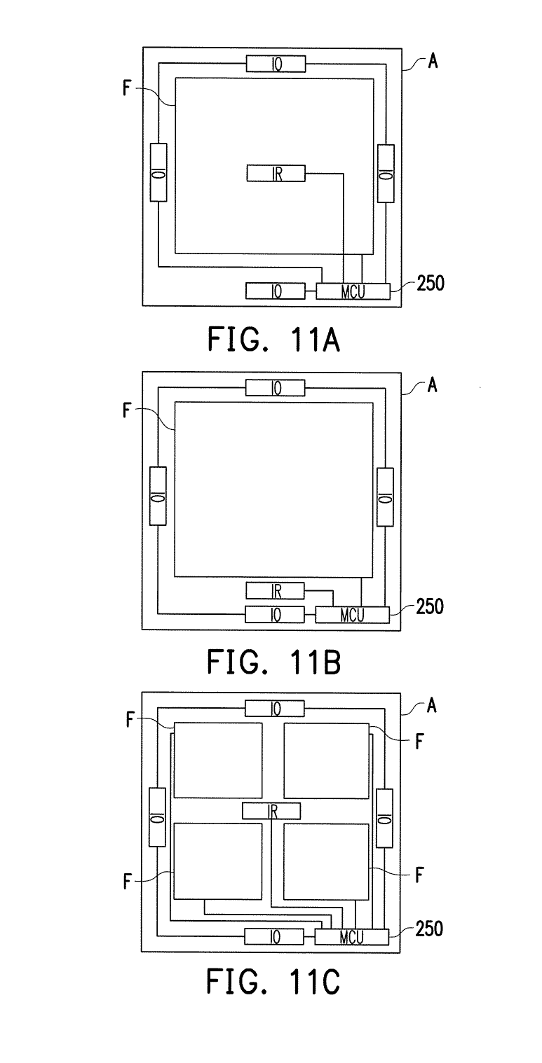

FIGS. 11A to 11C are schematic views illustrating configurations of an assembly pad according to another embodiment of the invention. In the embodiment, the assembly pad A is further combined with a force sensor F. In the assembly pad A of FIG. 11A, one force sensor is disposed, and the infrared light source IR is disposed at the center of the force sensor F. In the assembly pad A of FIG. 11B, one force sensor is disposed, and the infrared light source IR is disposed at a position not overlapped with the force sensor F. In the assembly pad A of FIG. 11C, the infrared light source IR is disposed at the center, whereas four force sensors F are centered around the infrared light source IR without being overlapped with the infrared light source IR. The position where the infrared light source IR is disposed and the number of the infrared light source IR may be modified based on the precision requirement of the system and the maturity of the development of the camera lens for the image capturer 230. The invention does not intend to limit the position of the infrared light source IR at the center or limit the number of the infrared light source IR to be four.

In view of the foregoing, the light emitting assembly pads are incorporated in the embodiments of the invention. A range of activity is defined by using the assembly pads, so as to track a specific object in the range of activity. The assembly pads have a simple structure and may be assembled manually. Thus, the assembly pads are not only easy to assemble, but are also easy to remove. Besides, the number of the assembly pads may be increased or decreased based on the needs, making the use of the assembly pads more flexible and expandable. Moreover, the assembly pads are applicable in various places and shapes, and may also be used on the desk, the wall, or other surfaces, as long as interaction is required. Hence, the assembly pads according to the embodiments of the invention have a broader applicability. The assembly pads according to the embodiments of the invention are not only applicable for interaction of virtual reality or augmented reality, but are also applicable in home care as well as position tracking of human beings or animals.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An object-tracking method, comprising:
emitting a light beam by a light emitter of each of a plurality of assembly pads, wherein the assembly pads are assembled to form a light emitting region;
continuously capturing a plurality of images toward the assembly pads in the light emitting region by an image pickup apparatus, wherein each of the images comprises a plurality of light regions formed by the light beams;
analyzing a first image and a second image to calculate a change of movement of the light regions, wherein the first image and the second image are adjacent images in the images; and
determining a motion state of the image pickup apparatus based on the change of movement.

2. The object-tracking method as claimed in claim 1, wherein analyzing the first image and the second image to compute the change of movement of the light regions comprises:
locking a designated light region in each of the first image and the second image; and
calculating a direction of movement and an amount of movement on a horizontal plane based on a coordinate position of the designated light region in the first image and a coordinate position of the designated light region in the second image.

3. The object-tracking method as claimed in claim 1, wherein analyzing the first image and the second image to compute the change of movement of the light regions comprises:
locking an imaging position in each of the first image and the second image; and
recording a first light region of the imaging position in the first image;
recording a second light region of the imaging position in the second image;
obtaining a direction of movement on a horizontal plane based on a positional relation between the first light region and the second light region; and
obtaining an amount of movement on the horizontal plane based on the number of light regions included between the first light region and the second light region.

4. The object-tracking method as claimed in claim 1, wherein analyzing the first image and the second image to compute the change of movement of the light regions comprises:
locking a designated light region in each of the first image and the second image;
recording a first interval when the same interval is kept between the designated light region and the light regions adjacent to the designated light region in the first image;
recording a second interval when the same interval is kept between the designated light region and the light regions adjacent to the designated light region in the second image;
obtaining a direction of movement and an amount of movement on a vertical axis based on a change between the first interval and the second interval under a circumstance that the first interval differs from the second interval.

5. The object-tracking method as claimed in claim 4, further comprising:
determining that the change of movement is a horizontal movement under a circumstance that the first interval is equal to the second interval.

6. The object-tracking method as claimed in claim 1, wherein analyzing the first image and the second image to compute the change of movement of the light regions comprises:
determining whether there is any change between slopes of lines formed by the light regions on an exterior side in the first image and the second image,
wherein determining the motion state of the image pickup apparatus based on the change of movement comprises:
calculating a rotation angle of the image pickup apparatus based on the change between the slopes.

7. The object-tracking method as claimed in claim 1, further comprising:
obtaining an identity code of each of the assembly pads;
driving the assembly pads to sequentially emit light beams;
obtaining a physical space location where each of the assembly pads is arranged based on a light signal and a captured image that are received; and
matching the identity code and the corresponding physical space location to obtain a correspondence map.

8. The object-tracking method as claimed in claim 1, further comprising:
capturing a correction image toward the assembly pads in the light emitting region by the image pickup apparatus and displaying the correction image on a screen;
displaying an ideal light region above the correction image on the screen; and
performing a correction process in the ideal light region and the light regions in the correction image.

9. The object-tracking method as claimed in claim 1, wherein each of the assembly pads is provided with a male/female mechanical connector on an edge, and each of the assembly pads is assembled through the male/female mechanical connector.

10. The object-tracking method as claimed in claim 1, wherein the image pickup apparatus is mounted on an object, and the object is one of a helmet, a stick, a remote controller, a glove, a shoe cover, and clothes.

11. An object-tracking system, comprising:
a plurality of assembly pads, assembled to form a light emitting region, wherein each of the assembly pads comprises a light emitter configured to emit a light beam; and
an image pickup apparatus, comprising:
an image capturer continuously capturing a plurality of images toward the assembly pads in the light emitting region, wherein each of the images comprises a plurality of light regions formed by the light beams; and
an image analyzer, coupled to the image capturer, receiving the images, and analyzing the images, wherein the image analyzer analyzes a first image and a second image to calculate a change of movement of the light regions, the first image and the second image are adjacent images in the images, and the image analyzer determines a motion state of the image pickup apparatus based on the change of movement.

12. The object-tracking system as claimed in claim 11, wherein the image analyzer locks a designated light region in each of the first image and the second image and calculates a direction of movement and an amount of movement on a horizontal plane based on a coordinate position of the designated light region in the first image and a coordinate position of the designated light region in the second image.

13. The object-tracking system as claimed in claim 11, wherein the image analyzer locks an imaging position in each of the first image and the second image, records a first light region of the imaging position in the first image, records a second light region of the imaging position in the second image, obtains a direction of movement on a horizontal plane based on a positional relation between the first light region and the second light region, and obtains an amount of movement on the horizontal plane based on the number of light regions included between the first light region and the second light region.

14. The object-tracking system as claimed in claim 11, wherein the image analyzer locks a designated light region in each of the first image and the second image, records a first interval when the same interval is kept between the designated light region and the light regions adjacent to the designated light region in the first image, records a second interval when the same interval is kept between the designated light region and the light regions adjacent to the designated light region in the second image, and obtains a direction of movement and an amount of movement on a vertical axis based on a change between the first interval and the second interval under a circumstance that the first interval differs from the second interval.

15. The object-tracking system as claimed in claim 14 wherein under a circumstance that the first interval is equal to the second interval, the image analyzer determines that the change of movement is a horizontal movement.

16. The object-tracking system as claimed in claim 11, wherein the image analyzer determines whether there is any change between slopes of lines formed by the light regions on an exterior side in the first image and the second image, and calculates a rotation angle of the image pickup apparatus based on the change between the slopes.

17. The object-tracking system as claimed in claim 11, wherein the image analyzer obtains an identity code of each of the assembly pads, drives the assembly pads to sequentially emit light beams, obtains a physical space location where each of the assembly pads is arranged based on a light signal and a captured image that are received, and matches the identity code and the corresponding physical space location to obtain a correspondence map.

18. The object-tracking system as claimed in claim 11, wherein the image capturer captures a correction image toward the assembly pads in the light emitting region and displays the correction image on a screen, and the image analyzer displays an ideal light region above the correction image on the screen and perform is a correction process based on the ideal light region and the light regions in the correction image.

19. The object-tracking system as claimed in claim 11, wherein each of the assembly pads is provided with a male/female mechanical connector on an edge, and each of the assembly pads is assembled through the male/female mechanical connector.

20. The object-tracking system as claimed in claim 12, wherein the image pickup apparatus is mounted on an object, and the object is one of a helmet, a stick, a remote controller, a glove, a shoe cover, and clothes.
